(19) United States
(12) Patent Application Publication
(10) Pub. No.: US 2006/0188850 A1
(43) Pub. Date: Aug. 24, 2006

(54) Cosmetics kit and method of use

(76) Inventor: Cassandra Mills, Tarzana, CA (US)

Correspondence Address: FULWIDER PATTON, 6060 CENTER DRIVE, 10TH FLOOR, LOS ANGELES, CA, 90045, US

(21) Appl. No.: 11/064,305

(22) Filed: Feb. 23, 2005

(51) Int. Cl. G09B 19/00; A45D 33/24

(52) U.S. Cl. 434/100; 132/294

(57) ABSTRACT

The cosmetics kit includes a guide overlay placed in a cosmetics compact to identify elements in the cosmetics compact, and a booklet of instructions, and may include accessory tools such as one or more brushes or sponges.

### BACKGROUND OF THE INVENTION

This application relates to a cosmetics kit, and more generally relates to cosmetics kit and a system and method for using the cosmetics kit.

### DESCRIPTION OF RELATED ART

Cosmetics for cleansing, beautifying and changing the appearance of skin are commonly available commercially as separate items, or in cosmetics compacts typically containing a few related items, but a novice cosmetics user is usually faced with the tasks of extensive experimentation and sampling of cosmetics to find appropriate combinations of cosmetic items, with minimum guidance. Basic facial cosmetics typically include a foundation to be applied to the skin of the face, face power to be dusted on top of the foundation, rouge or blush for highlighting the cheeks, eye makeup, and lipstick or lip gloss. A foundation, such as vanishing cream for example, is used to provide an even, adherent base for the face powder which is to be applied over the foundation. Eye makeup typically includes a mascara to emphasize the eyelashes, eye shadow for the eyelids, an eyebrow pencil and eyeliner to accent the edges of the eyelids. A wide variety of colors, tones and hues of various cosmetics is commercially available.

Factors that influence the selection of appropriate individual cosmetic items may include a user's hair color, eye color, skin tones and facial structure, some of which may change periodically, or with aging. It would be desirable to provide a cosmetics kit that combines a selection of cosmetics with a color scheme pre-selected from a set of multiple colors schemes of cosmetics to be coordinated with such factors as skin tone, hair color, eye color, and facial features, for example. It would also be desirable to provide a system and method of using such a cosmetics kit that would provide a complete guide for the novice cosmetics user. The present invention meets these and other needs.

### SUMMARY OF THE INVENTION

Briefly and in general terms, the present invention provides for a cosmetics kit and a system and method for using the cosmetics kit, which includes a cosmetics box with a removable guide overlay placed in the cosmetics box to identify items in the kit, and optionally to give instructions for items in the kit. The kit also includes a booklet of instructions for items in the cosmetics box and correlating with the information on the guide overlay, and may include accessory tools and/or brushes. Specific items in the kit include cosmetics for the face, eyes, cheeks, and lips, with each kit having an assortment of cosmetics appropriate for a particular skin tone and/or ethnicity, a booklet of instructions to assist the user in selecting and using the cosmetics, and optionally accessory tools and/or brushes. In a currently preferred aspect, seven different color schemes or combinations are contemplated for different facial skin tones, hair colorings, and/or ethnicities. The method of use involves applying the cosmetics by matching the instructions for each item in the kit with instructions and/or identifying information on the guide overlay for each item, for each kit of a particular color scheme.

The invention accordingly provides for a cosmetics kit, including a cosmetics box with a base having a plurality of wells adapted to contain a corresponding plurality of cosmetics, respectively, and a guide overlay removably disposed over the base and the wells, the guide overlay bearing a plurality of informational labels disposed over corresponding wells in the base respectively, to identify the plurality of cosmetics in the wells. In a presently preferred embodiment, the guide overlay is a transparent film with informational labels printed on the transparent film. The box may optionally include a lid connected to the base, and the lid may optionally include an interior mirror. The cosmetics kit further includes a booklet containing instructions for assisting a user in selecting and using the plurality of cosmetics. The cosmetics kit may also include one or more accessory tools, such as one or more brushes, and one or more sponges. In a presently preferred aspect, the plurality of cosmetics includes an assortment of cosmetics for the face, eye shadow, blush for the cheeks, and lipstick. In another presently preferred aspect, the assortment of cosmetics is selected to have a color scheme coordinated for a particular skin tone selected from a plurality of skin tones. A plurality of different color schemes or combinations, such as seven color schemes or combinations, for example, are contemplated for different combinations of facial skin tones, hair colorings, eye color, facial features and/or ethnicities. The present invention also provides for a system and method for applying cosmetics in the cosmetics kit, by matching the informational labels' for the plurality of cosmetics in the cosmetics kit with corresponding instructions in the instructions booklet for the color scheme provided.

Other features and advantages of the present invention will become apparent from the following detailed description of the preferred embodiment in connection with the accompanying drawings, which illustrate the invention by way of example.

### BRIEF DESCRIPTION OF THE DRAWINGS

FIG. 1 is a front perspective view of the cosmetics compact, guide overlay, instructional booklet, tools and accessories of the cosmetics kit of the invention.

FIG. 2 is a front perspective view of the cosmetics compact and guide overlay of FIG. 1, showing the positioning of the guide overlay.

FIG. 3 is a perspective view of the instructional booklet of FIG. 1.

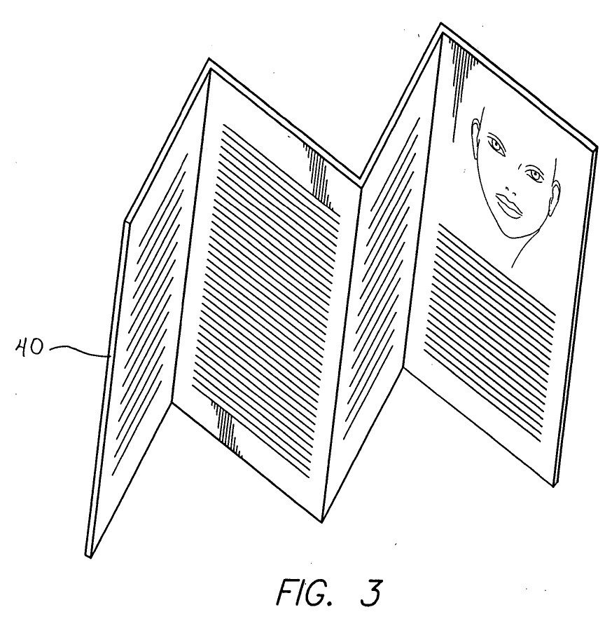

### DETAILED DESCRIPTION OF THE INVENTION

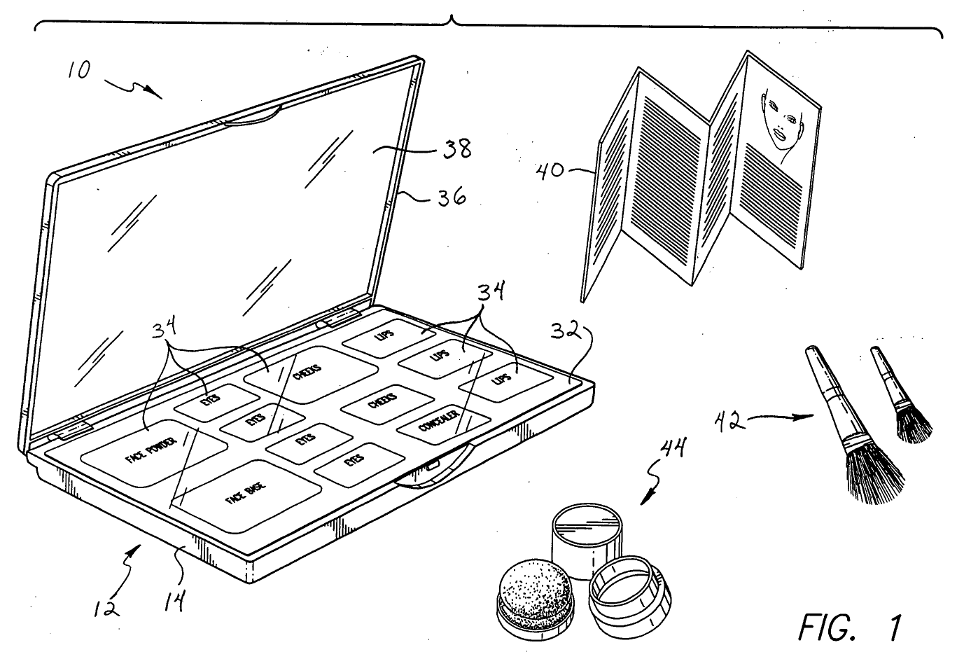

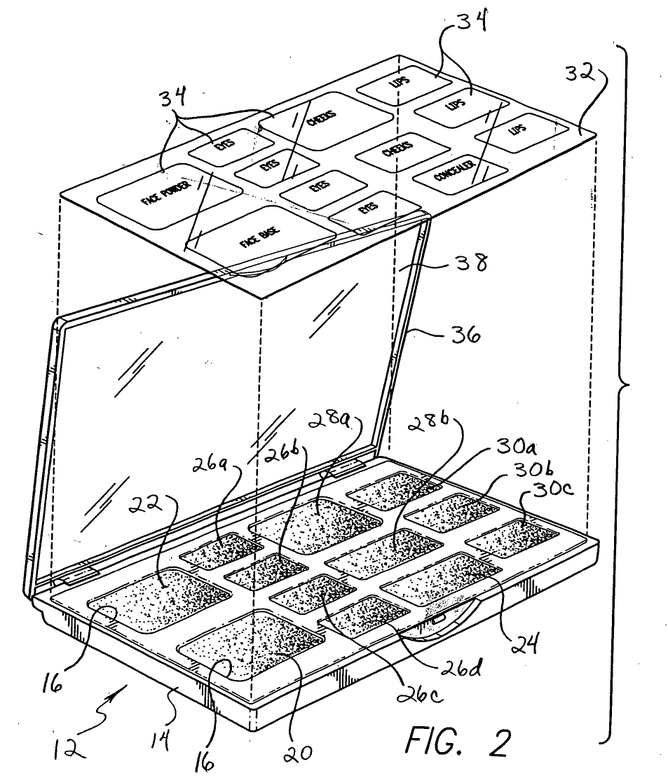

Referring to the drawings, which are provided by way of example, the invention provides for a cosmetics kit 10, including a compact or cosmetics box 12 having a base 14 with a plurality of wells 16 for containing a corresponding plurality of cosmetics, respectively, as illustrated in FIGS. 1 and 2. The plurality of cosmetics preferably includes an assortment of cosmetics for the face, such as a face base foundation 20, and a face powder 22, as well as a concealer cream 24, for covering skin blemishes. Also provided in the assortment of cosmetics is an assortment of eye shadows 26a, b, c, d, for providing appropriate accent, shadow and contour and highlight of the eyes. A blush cream or powder 28a, b is also provided for the cheeks of the face. A selection of lipsticks, lip glosses, or lip creams 30a, b, c is also provided. The assortment of cosmetics is preferably selected to have a color scheme coordinated for a particular skin tone selected from a plurality of skin tones, and in a presently preferred embodiment seven different color schemes or combinations are subjectively predetermined and provided for different combinations of facial skin tones, hair colorings, eye colorings, facial features and/or ethnicities. A guide overlay 32 is removably disposed over the base and the wells in the base, with the guide overlay bearing a plurality of informational labels 34 disposed over corresponding wells in the base, respectively, to identify the cosmetics in the wells. In a presently preferred embodiment, the guide overlay is a transparent film with informational labels printed on the transparent film. The guide overlay may also include' instructions in the informational labels for selecting and using the cosmetics in the wells.

A lid 36 is preferably hingedly connected to an edge 37 of the base, and the lid preferably includes an interior mirror 38. An instructional booklet 40 is also provided, containing instructions keyed to the informational labels on the guide overlay and the cosmetics in the cosmetics box for assisting a user in selecting and using a plurality of cosmetics. One or more accessory tools may also be provided in the cosmetics kit, such as one or more brushes 42, and one or more sponges 44, such as for applying the face powder.

It will be apparent from the foregoing that while particular forms of the invention has been illustrated and described, various modifications can be made without departing from the spirit and scope of the invention. Accordingly, it is not intended that the invention be limited, except as by the appended claims.

What is claimed:

1. A cosmetics kit, comprising:
a cosmetics box including a base having a plurality of wells for containing a corresponding plurality of cosmetics, respectively;
a guide overlay removably disposed over said base and said plurality of wells, the guide overlay bearing a plurality of informational labels disposed over corresponding ones of said plurality of wells in the base, respectively, to identify the plurality of cosmetics in the plurality of wells; and
a booklet containing instructions keyed to the informational labels on the guide overlay for assisting a user in selecting and using said plurality of cosmetics.

2. The cosmetics kit of claim 1, wherein said plurality of cosmetics comprises an assortment of cosmetics for a user's face, eye shadow, blush for the user's cheeks, and lipstick.

3. The cosmetics kit of claim 1, wherein said plurality of cosmetics is selected to have a color scheme coordinated for a particular skin tone selected from a plurality of skin tones.

4. The cosmetics kit of claim 1, wherein said assortment of cosmetics is selected from a set of a plurality of different color schemes subjectively predetermined to be coordinated with a combination selected from a group of facial skin tones, hair colorings, eye color, and facial features.

5. The cosmetics kit of claim 1, wherein said guide overlay comprises instructions for selecting or using said cosmetics in said corresponding ones of said plurality of wells, respectively.

6. The cosmetics kit of claim 1, wherein said cosmetics box further comprises a lid hingedly connected to an edge of the base.

7. The cosmetics kit of claim 6, wherein said lid includes an interior mirror.

8. The cosmetics kit of claim 1, further comprising at least one accessory tool selected from the group of brushes and sponges.

9. The cosmetics kit of claim 1, wherein said guide overlay is transparent.

10. A method for applying cosmetics in a cosmetics kit, comprising the steps of:
providing a cosmetics kit including
a) a cosmetics box including a base having a plurality of wells for containing a corresponding plurality of cosmetics, respectively, said plurality of cosmetics being selected to have a color scheme coordinated for a particular skin tone selected from a plurality of skin tones;
b) a guide overlay removably disposed over said base and said plurality of wells, the guide overlay bearing a plurality of informational labels disposed over corresponding ones of said plurality of wells in the base, respectively, to identify the plurality of cosmetics in the plurality of wells; and
c) a booklet containing instructions keyed to the informational labels on the guide overlay for assisting a user in selecting and using said plurality of cosmetics; and
applying said plurality of cosmetics by matching said informational labels for said plurality of cosmetics in the cosmetics kit with corresponding instructions in the booklet of instructions for said color scheme.

11. A system for applying cosmetics in a cosmetics kit, comprising:
a cosmetics box including a base having a plurality of wells for containing a corresponding plurality of cosmetics, respectively;
a guide overlay removably disposed over said base and said plurality of wells, the guide overlay bearing a plurality of informational labels disposed over corresponding ones of said plurality of wells in the base, respectively, to identify the plurality of cosmetics in the plurality of wells; and
a booklet containing instructions keyed to the informational labels on the guide overlay for assisting a user in selecting and using said plurality of cosmetics.

12. The system of claim 11, wherein said plurality of cosmetics comprises an assortment of cosmetics for a user's face, eye shadow, blush for the user's cheeks, and lipstick.

13. The system of claim 11, wherein said plurality of cosmetics is selected to have a color scheme coordinated for a particular skin tone selected from a plurality of skin tones.

14. The system of claim 11, wherein said assortment of cosmetics is selected from a set of a plurality of different color schemes subjectively predetermined to be coordinated with a combination selected from a group of facial skin tones, hair colorings, eye color, and facial features.

15. The system of claim 11, wherein said guide overlay comprises instructions for selecting or using said cosmetics in said corresponding ones of sand plurality of wells, respectively.

16. The system of claim 11, wherein said cosmetics box further comprises a lid hingedly connected to an edge of the base.

17. The system of claim 16, wherein said lid includes an interior mirror.

18. The system of claim 11, further comprising at least one accessory tool selected from the group of brushes and sponges.

19. The system of claim 11, wherein said guide overlay is transparent.
